(19) United States
(12) Patent Application Publication
(10) Pub. No.: US 2008/0292064 A1
(43) Pub. Date: Nov. 27, 2008

(54) METHODS AND APPARATUS TO CHARACTERIZE A DIGITAL SUBSCRIBER LINE (DSL) SUBSCRIBER LOOP

(76) Inventors: Xidong Wu, Livermore, CA (US); Donggen Zhang, Fremont, CA (US); Stuart Lynch Blackburn, San Ramon, CA (US); Sun-uk Park, Union City, CA (US); Richard Dennis Hart, Concord, CA (US); Jin Wang, Union City, CA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/751,353

(22) Filed: May 21, 2007

(51) Int. Cl. H04M 1/24

(52) U.S. Cl. 379/22.04

(57) ABSTRACT

Methods and apparatus to characterize a digital subscriber line (DSL) subscriber loop are disclosed. An example method comprises selecting a portion of a search space based on a measured transfer function response, the search space defining a plurality of combinations of transmission line parameters, and identifying a characterizing parameter of a digital subscriber line (DSL) subscriber loop from the selected portion of the search space, the characterizing parameter having an associated transfer function that substantially corresponds with the measured transfer function response.

### FIELD OF THE DISCLOSURE

This disclosure relates generally to transmission lines and, more particularly, to methods and apparatus to characterize a DSL subscriber loop.

### BACKGROUND

Communication systems using digital subscriber line (DSL) technologies are commonly utilized to provide Internet related services to subscribers, such as, for example, homes and/or businesses (also referred to herein as users, customers and/or customer-premises). DSL technologies enable customers to utilize DSL subscriber loops (e.g., ordinary twisted-pair copper telephone lines used to provide Plain Old Telephone System (POTS) services) to connect the customer to, for example, a high data-rate broadband Internet network, broadband service and/or broadband content. For example, a communication company and/or service provider may utilize a plurality of modems (e.g., a plurality of DSL modems) implemented by a DSL Access Multiplexer (DSLAM) (e.g., located at a central office (CO), a remote terminal (RT) or any other location) to provide DSL communication services to a plurality of modems located at respective customer-premises. For ease of discussion, DSL modems located in and/or implemented by a DSLAM (or similar equipment) are referred to herein as CO DSL modems, even though such DSL modems and/or DSLAMs may, additionally or alternatively, be located at other locations (e.g., a remote terminal (RT)) used to provide DSL services to customer-premises. In general, a CO DSL modem receives broadband service content from, for example, a backbone server and forms a digital downstream DSL signal to be transmitted to a customer-premises DSL modem. Likewise, the CO DSL modem receives an upstream DSL signal from the customer-premises DSL modem and provides the data transported in the upstream DSL signal to the backbone server. The speed at which data may be transmitted via a DSL subscriber loop may depend upon one or more characteristics of the DSL subscriber loop such as, for example, loop length, cable gauge(s), bridged tap location, bridged tap length, etc.

### BRIEF DESCRIPTION OF THE DRAWINGS

FIG. 1 is a schematic illustration of an example digital subscriber line (DSL) communication system constructed in accordance with the teachings of the invention.

FIG. 2 illustrates an example manner of implementing the example loop characterizer of FIG. 1.

FIG. 3 illustrates an example data structure that may be used to implement the example attenuation data of FIG. 2.

FIGS. 4 and 5 illustrate example results generated by any or all of the example loop characterizer of FIGS. 1 and 2.

FIGS. 6, 7 and 8 are flowcharts representative of example machine accessible instructions which may be executed to implement any or all of the example loop characterizers of FIGS. 1 and 2.

FIG. 9 is a schematic illustration of an example processor platform that may be used and/or programmed to execute any or all of the example machine accessible instructions of FIGS. 6-8 to implement any or all of the example loop characterizers described herein.

### DETAILED DESCRIPTION

Methods and apparatus to characterize a digital subscriber line (DSL) subscriber loop are disclosed. A disclosed example method includes selecting a portion of a search space based on a measured transfer function response, the search space defining a plurality of combinations of transmission line parameters, and identifying a characterizing parameter of a DSL subscriber loop from the selected portion of the search space, the characterizing parameter having an associated transfer function that substantially corresponds with the measured transfer function response. A disclosed example apparatus includes a selector to eliminate a portion of a database based on a presence of at least one of a dip or a peak in a measured transfer function response, the search space defining a plurality of combinations of transmission line parameters, and a data fitter to identify a characterizing parameter of a DSL subscriber loop from a remaining portion of the database, the characterizing parameter having an associated transfer function that substantially corresponds with the measured transfer function response.

In the interest of brevity and clarity, throughout the following disclosure references will be made to connecting a digital subscriber line (DSL) modem and/or a DSL communication service to a customer. However, it will be readily apparent to persons of ordinary skill in the art that connecting a DSL modem to a customer involves, for example, connecting a first DSL modem operated by a communications company (e.g., a central office (CO) DSL modem implemented by a DSL access multiplexer (DSLAM)) to a second DSL modem located at, for example, a customer-premises (e.g., a home and/or place of business owned, leased and/or operated by a customer) via a twisted-pair telephone line (i.e., a wire-pair). The customer-premises (e.g., the second) DSL modem may be further connected to other communication and/or computing devices (e.g., a personal computer, a set-top box, etc.) that the customer uses and/or operates to access a service (e.g., Internet access, Internet protocol (IP) Television (TV), etc.) via the CO DSL modem, the customer-premises DSL modem, the wire-pair and the communications company.

Moreover, while methods and apparatus to characterize a DSL subscriber loop are described herein, persons of ordinary skill in the art will readily appreciate that the example methods and apparatus may additionally or alternatively be used to qualify other transmission lines, wires and/or cables for other communication services. Other example transmission lines, wires and/or cables include, but are not limited to, those associated with public switched telephone network (PSTN) systems, public land mobile network (PLMN) systems (e.g., cellular), wireless distribution systems, wired or cable distribution systems, coaxial cable distribution systems, Ultra High Frequency (UHF)/Very High Frequency (VHF) radio frequency systems, satellite or other extra-terrestrial systems, cellular distribution systems, power-line broadcast systems, fiber optic networks, and/or any combination and/or hybrid of these devices, systems and/or networks.

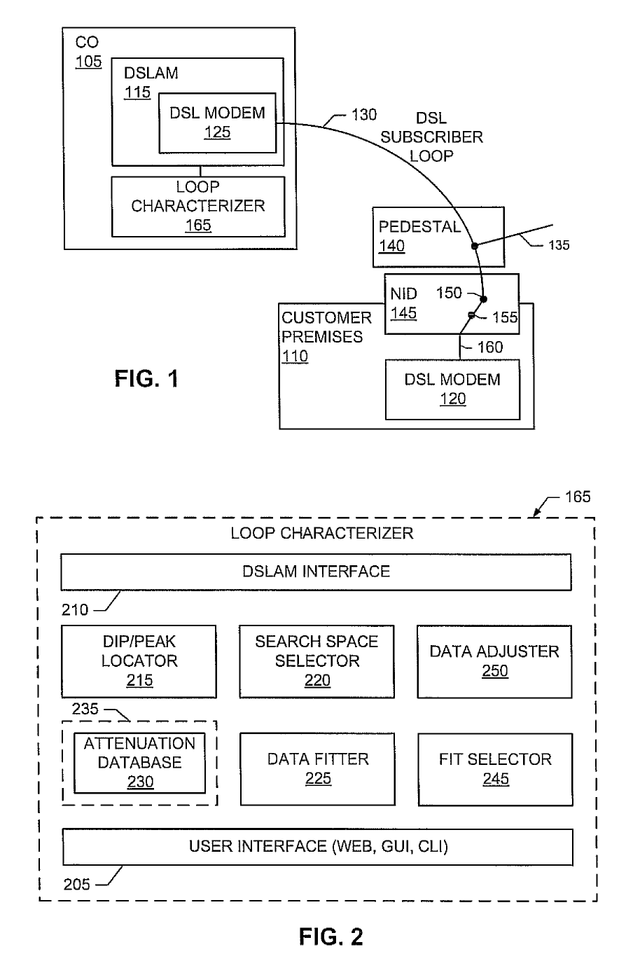

FIG. 1 illustrates an example DSL communication system in which a central office (CO) 105 provides data and/or communication services (e.g., telephone services, Internet services, data services, messaging services, instant messaging services, electronic mail (email) services, chat services, video services, audio services, gaming services, etc.) to one or more customer-premises, one of which is designated at reference numeral 110. To provide DSL communication services to the customer-premises 110, the example CO 105 of FIG. 1 includes any number and/or type(s) of DSLAMs (one of which is designated at reference numeral 115) and the example customer-premises 110 includes any type of DSL modem 120. Additionally or alternatively, data and/or communication services may be provided by any number and/or type(s) of DSLAMs located in and/or implemented at an RT 105. The example DSLAM 115 of FIG. 1 includes and/or implements one or more CO DSL modems (one of which is designated at reference numeral 125), for respective ones of customer-premises locations. The example DSLAM 115, the example CO DSL modem 125 and/or the example DSL modem 120 of FIG. 1 may be implemented, for example, in accordance with the ITU-T G.992.x family of standards for asymmetric high-speed DSL (ADSL), the ITU-T G.993.x family of standards for very high-speed DSL (VDSL) and/or the ITU-T G.997.x family of standards for management of DSL modems.

In the illustrated example of FIG. 1, the DSLAM 115 provides the DSL service to the DSL modem 120 at the customer-premises 110 via a DSL subscriber loop 130. DSL subscriber loops are sometimes also referred to in the industry as “loops” and/or “wire-pairs.” While throughout this disclosure reference is made to the example DSL subscriber loop 130 of FIG. 1, persons of ordinary skill in the art will readily appreciate that a DSL subscriber loop used to provide a DSL service to a customer-premises location (e.g., the location 110) may include and/or be constructed from one or more segments of twisted-pair telephone wire (e.g., a combination of a feeder one (F1) cable, a distribution cable, a drop cable, and/or customer-premises wiring), terminals and/or distributions points (e.g., a serving area interface (SAI), a serving terminal, a vault and/or a pedestal). Such segments of twisted-pair telephone wire may be spliced and/or connected end-to-end, and/or may be connected at only one end thereby creating one or more bridged taps. The example DSL subscriber loop 130 of FIG. 1 has a bridged tap 135 that is coupled to the DSL subscriber loop 130 at a pedestal 140. However, not all DSL subscriber loops have a bridged tap. Moreover, bridged taps may be coupled to DSL subscriber loops at locations other than a pedestal (e.g., an SAI, a serving terminal, a vault, a remote terminal, and/or a CO). Regardless of the number, type(s), gauge(s) and/or topology of twisted-pair telephone wires used to construct the example DSL subscriber loop 130, it will be referred to herein in the singular form but it will be understood to refer to one or more twisted-pair telephone wire segments and may include one or more bridged taps. Moreover, if a passive network interface device (NID) 145 is used to couple the DSL subscriber loop 130 to the DSL modem 120, the DSL subscriber loop 130 includes the cabling 160 coupling the DSL modem 120 to the NID 145. However, if an active NID 145 is used to couple the DSL subscriber loop 130 to the DSL modem 120, the DSL subscriber loop 130 does not include the cabling 160 because in such examples, DSL signals are terminated at the NID 145 (e.g., the DSL modem 120 is implemented at and/or within the NID 145).

As commonly used in the industry, the term “network demarcation point” denotes a location where cabling and/or equipment associated with a service provider (e.g., associated with the CO and/or RT 105 and/or the DSLAM 115) is physically, electrically and/or communicatively coupled to cabling and/or equipment associated with a customer-premises, a subscriber, a user and/or a customer (e.g., the example DSL modem 120). Such subscriber cabling and/or equipment is often owned by the customer but may, in some instances, be owned, leased and/or otherwise provided by the service provider. Typically a network demarcation unit (e.g., the example NID) 145) is located at the network demarcation point (e.g., on the outside of an exterior wall of the customer-premises 110) to implement the physical, electrical and/or communicative coupling between the subscriber and service provider sides of the network demarcation point. The example NID 145 of FIG. 1 comprises a passive NID and contains a first set of screw terminals, jacks and/or jumpers 150 to couple the DSL subscriber loop 130 to the NID 145, and contains a second set of screw terminals, jacks and/or jumpers 155 to couple subscriber cabling 160 to the NID 145. In such examples, the NID 145 couples the two sets of cabling 130 and 160 across the NID 145.

In some examples, to reduce and/or eliminate the effects of telephone wiring (not shown) within the customer-premises 110, the example DSL modem 120 is located and/or implemented at and/or within the NID 145 (e.g., the NID 145 comprises an active NID). However, the DSL modem 120 need not be implemented at and/or within the NID 145. For example, the DSL modem 120 could be implemented elsewhere within the customer-premises 110. Alternatively, the DSL modem 120 may be partially implemented within the NID 145. For example, a device (e.g., a POTS splitter) may be installed and/or implemented within the NID 145 to isolate the effects of telephone wiring and/or telephones (not shown) located in the customer-premises 110 from the DSL modem 120.

As defined and/or described by any past, present and/or future standards and/or specifications (e.g., the ITU-T G.992x family of standards, the ITU-T G.993.x family of standards, and/or the G.997.x family of standards), the example DSL modems 120 and 125 of FIG. 1 perform one or more measurements of the DSL subscriber loop 130 during, for example, DSL modem initialization. Such measurements are commonly used to train and/or adapt receiver modules of the DSL modems 120 and 125 based on the DSL subscriber loop 130. During modem initialization, the DSL modem 125 transmits one or more signals that allows the DSL modem 120 to measure, compute and/or estimate the attenuation of the DSL subscriber loop 130 at one or more frequencies and/or in one or more frequency bands. The attenuation of the DSL subscriber loop 130 may also be measured, computed, estimated and/or updated during steady-state operation (e.g., while user data is being transmitted). The DSL modem 120 may then send one or more values representative of the attenuation of the DSL subscriber loop 130 to the DSL modem 125 for use by the DSL modem 125, the DSLAM 115 and/or other equipment coupled to the DSLAM 115 (e.g., a DSL management server (not shown) and/or a loop characterizer 165). Such attenuation data is also referred to in the industry as “transfer function data,” “a transfer function,” “a transfer function response,” “a channel response,” and/or a logarithm of a channel response (H) (i.e., so called “HLOG values”). The attenuation data may be sent, exchanged and/or otherwise provided by the DSL modem 120 to the DSL modem 125 and/or the DSLAM 115 during modem initialization as defined by, for example, the ITU G.993.x family of standards, and/or by using management protocol(s), packet(s), frame(s) and/or message(s) defined by, for example, the ITU-T G.997.x family of standards. Likewise, the DSL modem 120 transmits one or more signals (at the same or different times) that allows the DSL modem 125 to measure, compute and/or estimate the attenuation of the DSL subscriber loop 130 at one or more frequencies and/or for one or more frequency bands from the opposite end of the loop. The DSL modem 125 may provide and/or send the same to the DSL modem 120, the DSLAM 115 and/or the DSL management server.

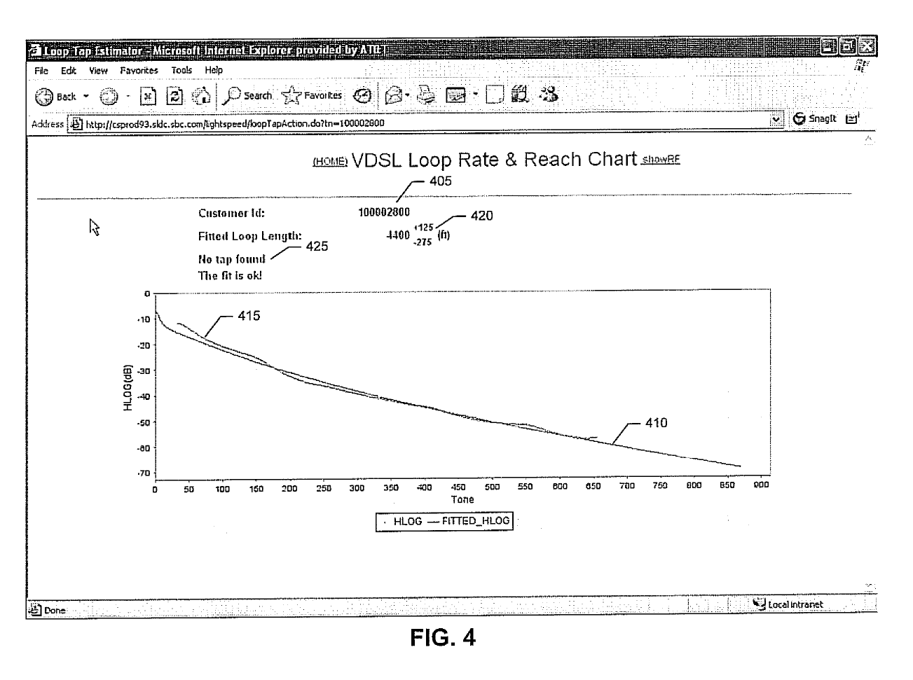

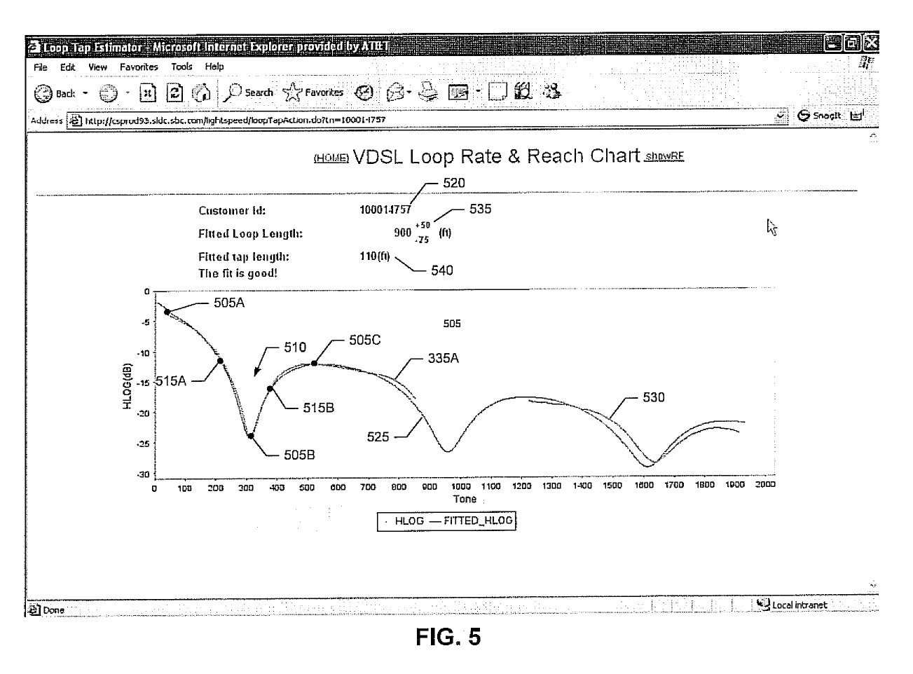

One or more parameters that characterize the DSL subscriber loop 130 may affect the DSL connection rate(s) supported by the DSL modems 120 and 125 via the DSL subscriber loop 130. Example characterizing parameters include, but are not limited to, the overall length of the DSL subscriber loop 130, the length(s) of one or more wire segments comprising the DSL subscriber loop 130, the gauge(s) of one or more wire segments comprising the DSL subscriber loop 130, whether one or more bridged taps (e.g., the example bridged tap 135) are coupled to the DSL subscriber loop 130, the location(s) of any coupled bridged taps, the length(s) of any coupled bridged taps, and/or the gauge(s) of any coupled bridged taps. In general, the signal attenuation of the DSL subscriber loop 130 increases with frequency. The rate of increase of the signal attenuation depends upon the overall length of the DSL subscriber loop 130. When there is not a bridged tap present, the transfer function decreases (i.e., the signal attenuation increases) along a generally smooth and/or monotonic curve (e.g., the example curve 410 of FIG. 4). When there is a bridged tap present (e.g., the example bridged tap 135), the transfer function generally includes one or more oscillations, peaks and/or dips (e.g., see the example curve 525 of FIG. 5). The shape(s) (e.g., width(s) and/or depth(s)) of any oscillation(s), peak(s) and/or dip(s) (in the frequency domain) are determined by the length(s) of the bridged tap(s).

To compute, estimate and/or otherwise determine one or more characterizing parameters of the DSL subscriber loop 130, the example DSL communication system of FIG. 1 includes the example loop characterizer 165. Characterizing parameters of the DSL subscriber loop 130 may be used during, for example, provisioning, installation, servicing and/or offering of a DSL service to a subscriber via the DSL subscriber loop 130. For example, a DSL management server can access and/or obtain one or more characterizing parameters of the DSL subscriber loop 130, and then use the same to make decisions regarding DSL services for the DSL subscriber loop 130 (e.g., to qualify the DSL subscriber loop for a particular DSL service). While the example loop characterizer 165 of FIG. 1 is implemented and/or located at the example CO and/or RT 105, the example loop characterizer 165 may be implemented elsewhere. For example, the loop characterizer 165 may be implemented at an operations support location, a customer service location, a technical support location, a field service location, a remote terminal, the customer premises 110, etc. The example loop characterizer 165 of FIG. 1 uses HLOG values (e.g., channel transfer function data and/or DSL subscriber loop attenuation data) measured, computed and/or estimated by one or both of the DSL modems 120 and 125. In the illustrated example, the loop characterizer 165 is communicatively coupled (although not necessarily electrically coupled) to the DSLAM 115, and collects, receives and/or otherwise obtains HLOG values via the DSLAM 115. However, the loop characterizer 165 may, additionally or alternatively, collect, receive and/or otherwise obtain HLOG values from other devices and/or servers (e.g., from the DSL modem 120 and/or from a DSL management server (not shown) which collects and/or stores information pertaining to DSL services provided by one or more DSLAMs, COs and/or remote terminals). An example manner of implementing the example loop characterizer 165 of FIG. 1 is described below in connection with FIG. 2.

In the past, the determination of a characterizing parameter for a DSL subscriber loop (e.g., the example DSL subscriber loop 130) has relied on the brute-force comparison of a measured transfer function (e.g., a set of HLOG values) to a plurality of computed theoretical transfer functions. However, because the number of possible configuration(s) and/or topology(-ies) of DSL subscriber loops is very large, the number of brute-force comparisons that need to be made to accurately identify the characterizing parameter quickly overwhelms readily available computing resources. For example, VDSL modems commonly utilize frequencies between 8 thousand cycles per second (kHz) and 17 million cycles per second (MHz) so that a measured transfer function may contain up to 4000 data points (assuming a 4.3125 kHz tone spacing). If a DSL subscriber loop may have as many as two bridged taps, a three dimensional search (e.g., loop length, bridged tap #1 length and bridged tap #2 length) of a database is required. Depending upon the desired accuracy, each dimension may include hundreds or thousands of lengths. Thus, the number of combinations (each requiring 4000 data points) that must be compared may easily exceed 10⁶ (assuming only 100 possible lengths per dimension). Moreover, because the storage of such a large search is prohibitive (e.g., 4·10⁹ words of storage), theoretical transfer functions are traditionally computed (e.g., using an ABCD model) for each combination while the search is performed, further increasing the computational complexity of existing solutions and, thereby, making impractical the real-time determination of characterizing parameters of DSL subscriber loops by existing loop characterization solutions.

The example loop characterizer 165 of FIG. 1 achieves and/or is able to perform the characterization of DSL subscriber loops in near real-time (e.g., less than one second versus a few hours) by, among other things: a) using a measured transfer function (e.g., HLOG values) to select a portion of the search space in which a solution is to be identified and b) using efficient (e.g., small) data structures from which theoretical transfer function responses can be easily and/or quickly approximated. To reduce the memory required to store and/or the computing resources required to compute theoretical transfer function responses, the example loop characterizer 165 approximates theoretical transfer function responses by combining (e.g., adding together) attenuation contributions from three sources: 1) attenuation due to the overall loop length, 2) attenuation due to a first bridged tap, and 3) attenuation due to a second bridged tap. In particular, the example loop characterizer 165 of FIG. 1 approximates the theoretical transfer function of a DSL subscriber loop using the following mathematical expression:

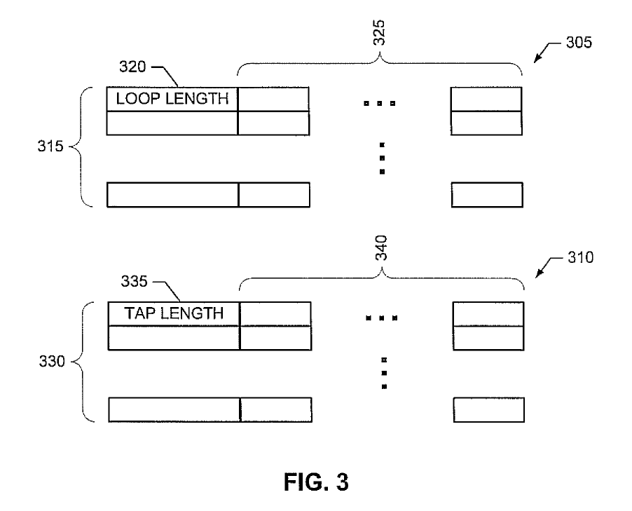

HLOG(n, loop_length, tap_length)=HLOG(n, loop_length)+HLOG(n, tap_length1)+HLOG(n, tap_length2), EQN (1)

where n is used to index the arrays of HLOG values, loop_length is the overall length of the DSL subscriber loop 130, tap_length1 is the length of a first bridged tap (if present), and tap_length2 is the length of a second bridged tap (if present). An example data structure that may be used to implement HLOG(n, loop_length) and HLOG(n, tap_length) is described below in connection with FIG. 3. By approximating theoretical transfer functions using EQN (1), the example loop characterizer 165 can more efficiently compute a transfer function response for any combination of overall loop length and bridged tap(s) than by direct application of an ABCD model. Unexpectedly, experiments have demonstrated that EQN (1) produces transfer function responses that are within one percent (1%) of values developed by traditional methods. In general, the size of the arrays of HLOG values is quite large (e.g., 4000 points). However, as described below, the example loop characterizer 165 selects an appropriate and/or sufficient subset of the HLOG values (e.g., 40 points) to use while performing a fit of measured HLOG values to computed theoretical HLOG values; thereby substantially streamlining the search. Therefore, the techniques described herein significantly reduce search time and/or resources while unexpectedly reaching substantially the same accuracy of the more laborious prior approaches. Moreover, the techniques described herein correctly characterize DSL subscriber loops under conditions where traditional methods may fail. For example, when only a portion of the frequencies available to a DSL modem are used (e.g., VDSL modems wherein different frequency bands are defined), and/or when measured HLOG values contain some distortion(s) (e.g., one or more tones that have unusual HLOG values).

To reduce the number of combinations that need to be considered when locating a set of theoretical HLOG values that most closely match measured HLOG values, the example loop characterizer 165 of FIG. 1 uses the measured transfer function (e.g., measured HLOG values) to select a portion of a universe of possible combinations. The universe of possible combinations represents all possible combinations of overall loop length(s) and bridged tap length(s) (i.e., the search space universe) and, as described above, can be quite large (e.g., more than 10⁶ combinations). In some examples, the techniques described herein further significantly reduce search time and resources by selecting only that portion of the search space universe beneficial to unexpectedly reaching substantially the same accuracy as the more laborious prior approaches. For example, recognizing that a DSL subscriber loop that does not have any bridged taps has a generally smooth and/or monotonic channel response, the example loop characterizer 165 detects whether any oscillations, peaks and/or dips are present in the channel response. As described above, such oscillations, peaks and/or dips are indicative of the presence of one or more bridged taps. Thus, the absence of any oscillations, peaks and/or dips indicates that it is likely that no bridged taps are present and, thus, that a portion of the search space universe that only includes overall loop lengths needs to be considered (i.e., a one dimensional search may be utilized). Moreover, because the channel response when no bridged tap is present is generally smooth and/or monotonic, only a subset of the channel response values (e.g., 40 rather than 4000) is needed to characterize the channel response. In particular, only the subset of the measured channel responses need be compared to the corresponding subset of computed channel responses to determine a characterizing parameter. For example, a random and/or predetermined (e.g., every 10^{th} value) subset of the channel response values could be used. More data points and/or values may be utilized to improve accuracy, if desired.

Likewise, the presence of one or more oscillations, peaks and/or dips in the channel response indicates that one or more bridged taps are likely to be present. When it is likely that one or more bridged taps are present, the example loop characterizer 165 of FIG. 1 considers combinations of overall loop length(s) and bridged tap length(s). To keep the size of the selected search space portion small as possible while unexpectedly maintaining the accuracy of the techniques described herein relative to more laborious prior approaches, the example loop characterizer 165 of FIG. 1 estimates the most likely minimum and maximum overall loop lengths corresponding to the channel response. For example, the loop characterizer 165 selects data points corresponding to any local maxima of the channel response, and uses those to estimate a first overall loop length. Likewise, the loop characterizer 165 selects data points corresponding to any local minima of the channel response, and uses those to estimate a second overall loop length. The first and second overall loop lengths can then be used to select a portion of the search space universe that only includes overall loop lengths falling between the first and second overall loop lengths. In some examples, the first and overall loop lengths are adjusted prior to the selection of the portion of the search space universe. For example, the greater of the first and second overall loop lengths can be increased by, for example, 200 feet (ft.), and the lesser of the first and second overall loop lengths can be decreased by, for example, 200 ft. In the illustrated example, the amount of adjustment is selected to increase the probability of identifying the best solution while reducing the exploration of unnecessary search space combinations.

To reduce the likelihood of falsely detecting an oscillation, dip and/or peak, the example loop characterizer 165 of FIG. 1 compares the height/depth of each oscillation, dip and/or peak to a first threshold (e.g., 0.5 decibels (dB)) and compares the width of each oscillation, dip and/or peak to a second threshold (e.g., 20 carriers). Only when an oscillation, dip and/or peak is sufficiently high/deep and wide does the example loop characterizer 165 of FIG. 1 consider the oscillation, dip and/or peak as being indicative of the presence of one or more bridged taps. Like the scenario when no bridged tap was present, only a subset of the channel response values are used to determine a characterizing parameter for a DSL subscriber loop 130 containing a bridged tap. For example as illustrated in FIG. 5, each oscillation, dip and/or peak can be characterized by data points that occur at approximately the maximum and minimum points of the oscillation, dip and/or peak (e.g., points 505A, 505B and 505C of the dip 510), and points (e.g., points 515A and 515B) selected approximately midway between the maximum and minimum points. The data points that characterize each oscillation, dip and/or peak (e.g., the points 505A-C and 515A-B) are then used when comparing the measured channel response with various combinations from the selected portion of the search space universe. Such a collection of data points will be substantially smaller (e.g., 40) than the total number of data points in the channel response (e.g., 4000). In some examples, if the selected collection of data points is smaller than 40, the example loop characterizer 165 randomly selects additional data points to consider. More data points may be utilized to improve accuracy, if desired.

To compare measured and computed HLOG values (i.e., channel responses), the example loop characterizer 165 of FIG. 1 employs a chi-square (X²) technique. The X² technique employed by the example loop characterizer 165 computes a metric (e.g., a X² value) that represents a weighted difference between values of a measured channel response (e.g., measured HLOG values) and values of an approximated theoretical channel response (e.g., computed HLOG values). A X² value may be computed for a presently consider search space combination using the following mathematical expression:

$${χ}^{2} = \frac{1}{N} {\sum }_{n ∈ \{ selected data points \}} w ( n ) {( {HLOG}_{m} ( n ) - {HLOG}_{c} ( n ) )}^{2} , \qquad EQN ( 2 )$$

where HLOGₘ are measured HLOG values, HLOG_{c} are computed HLOG values for a presently considered search space combination, w( ) is a set of weighting values, n is taken from the selected set of data points (e.g., 40 data points selected as described above) and N is the number of selected data points. The smaller the value of X², the closer HLOGₘ matches the presently considered search space combination HLOG_{c}. Thus, the minimum X² identifies the search space combination that most closely matches the measured HLOG values and, thus, identifies the characterizing parameter(s) that most closely represent the measured HLOG values. As used herein, performing a “data fit” includes comparing measured HLOG values with one or more sets of computed HLOG values (from a selected portion of the search space universe) to identify the set of computed HLOG values that most closely matches the measured HLOG values. The set of weighting values w( ) allow channel responses at certain frequencies to be weighted as more useful and/or beneficial than other frequencies, and/or to equalize the effect of different frequencies (e.g., on the determination of overall loop length). For example, for low frequencies a 1 dB difference between measured and computed HLOG values represents a change in overall length of 300 ft., but for higher frequencies a 1 dB difference in HLOG values represents a change in overall length of 100 ft. In the illustrated example, the statistical weight of lower frequencies is approximately 3 times higher than for higher frequencies. Thus, if HLOG values are not weighted, a measured HLOG curve that passes within 3 dB of computed HLOG values at both low and high frequencies represents a 900 ft. error at low frequencies and a 300 ft. error at higher frequencies. Accordingly, in the illustrated example, measured HLOG for higher frequencies have corresponding larger weighting values w( ).

As described above, X² values are an indicator of how well computed HLOG values fit (i.e., match) measured HLOG values. However, because the HLOG values may contain unknown measurement errors, the X² values may not directly represent the standard deviation of the fit. The example loop characterizer 165 of FIG. 1 classifies X₂ values into one of three categories: “good fit”, “ok fit” and “bad fit”. A “good fit” occurs when the measured and computed HLOG values fit each other quite well. An “ok fit” occurs when the measured and computed HLOG values generally agree (e.g., there may be some points that mismatch, but the general shapes match). A “bad fit” occurs when the measured and the computed HLOG values generally disagree. To determine whether a fit is “good,” “ok” or “bad,” the X² value is normalized using, for example, EQN (3).

$${χ}_{norm}^{2} = \frac{2000 \cdot {χ}^{2}}{fitted\_loop \_length} , \qquad EQN ( 3 )$$

where fitted_loop_length is the overall loop length of the presently considered member of the selected portion of the search space universe (i.e., a presently considered search space combination). A fit can be classified as “good,” ok or “bad” using, for example, the following logic:

Fit without bridged tap:

if Xₙₒᵣₘ²<0.04, then fit=“good”

if Xₙₒᵣₘ²<0.075, then fit=“ok”

else, then fit=“bad” EQN (4)

Fit with bridged tap:

if Xₙₒᵣₘ²<0.1, then fit=“good”

if Xₙₒᵣₘ²<0.3, then fit=“ok”

else, then fit=“bad”

As described in further detail below, if the example loop characterizer 165 of FIG. 1 makes an initial determination that no bridged tap is present and then identifies that the fit is “ok” rather than “good”, the example loop characterizer 165 performs a second data fit using a selected portion of the search space universe that includes bridged taps. Likewise, if the example loop characterizer 165 makes an initial determination that one or more bridged taps are present and then identifies that the fit is “ok” rather than “good”, the example loop characterizer 165 performs a second fit using a selected portion of the search space universe that includes no bridged tap. In both cases, if the second data fit yields a better result (i.e., a lower X² value), the second fit is selected. Other criteria and/or logic may, additionally or alternatively, be applied to reduce the occurrence of false and/or incorrect results. For example, for a bridged tap length of greater than 1000 ft. to be considered as accurate, the measured HLOG values need to include at least 5 local maxima and/or minima. In another example, if a good fit has not been identified after trying a data fit with and without bridged taps, the example loop characterizer 165 adjusts the measured HLOG values to compensate for losses caused by co-axial and/or diplexers located, for example, inside the customer-premises 110. In some examples, losses due to co-axial and/or diplexers are available as pre-computed values that may be obtained from a machine accessible data structure (e.g., a data file).

FIG. 2 illustrates an example manner of implementing the example loop characterizer 165 of FIG. 1. To allow the example loop characterizer 165 of FIG. 2 to be used to determine one or more characterizing parameters of a DSL subscriber loop (e.g., the example DSL subscriber loop 130 of FIG. 1), the example loop characterizer 165 includes any type of user interface 205. The example user interface 205 of FIG. 2 may be implemented using one or more of a command-line interface (CLI), a graphical user interface (GUI), and/or a web-based interface. The example user interface 205 may be used to select a DSL subscriber loop to be characterized, to initiate determination of one or more characterizing parameters for the selected DSL subscriber loop, and/or to receive, provide and/or display characterization results for the selected DSL subscriber loop.

To allow the example loop characterizer 165 of FIG. 2 to collect, receive and/or otherwise obtain measured channel response data (e.g., measured HLOG values), the example loop characterizer 165 of FIG. 2 includes a DSLAM interface 210. The example DSLAM interface 210 of FIG. 2 implements any message(s), protocol(s) and/or exchange(s) that allow the loop characterizer 165 to obtain measured HLOG values for a DSL subscriber loop from a DSLAM (e.g., the example DSLAM 115 of FIG. 1), a DSL modem (e.g., any of the example DSL modems 120 and 125) and/or a DSL service manager (not shown).

To identify oscillations, peaks and/or dips, the example loop characterizer 165 of FIG. 2 includes a dip/peak locator 215. The example dip/peak locator 215 of FIG. 2 processes obtained measured HLOG values for a DSL subscriber loop to identify and/or locate oscillations, peaks and/or dips having heights/depths and widths that indicate that one or more bridged taps may be present on the DSL subscriber loop. For example to identify a dip, the example dip/peak locator 215 identifies a local minima and then measures the distance between two encompassing maxima (e.g., two maxima wherein one maxima is located on a first side of the local minima and a second maxima is located on a second side of the minima opposite the first side), and measures the depth of the local minima compared to the two encompassing maxima. If an oscillation, peak and/or dip is located, the example dip/peak locator 215 identifies data points that characterize the located oscillation, peak and/or dip (e.g., the example points 505A-C and 515A-B of FIG. 5)

To select a portion of the search space universe to search, the example loop characterizer 165 of FIG. 2 includes a search space selector 220. Based on whether the example dip/peak locator 215 locates a qualifying oscillation, peak and/or dip, the search space selector 220 selects a portion of the search space universe. For example, if no oscillation, peak or dip is identified, the example search space selector 220 selects a portion of the search space universe that only includes overall loop lengths. The search space selector 220 also selects a subset of the channel response values (e.g., every 10^{th} value) to be used when performing a subsequent data fit for the measured channel response values. If an oscillation, peak and/or dip is identified, the example search space selector 220 estimates the most likely minimum and maximum overall loop lengths corresponding to the measured channel response values, and uses the same to select the portion of the search space universe. For example, the minimum and maximum overall loop lengths are used to reduce the number of overall loop lengths included in the selected portion of the search space universe. The search space selector 220 also augments, if desired and/or necessary, the set of characterizing data points selected by the dip/peak locator 215.

To perform a data fit of the measured HLOG values to the portion of the search space universe selected by the example search space selector 220, the example loop characterizer 165 of FIG. 2 includes a data fitter 225. Within the selected portion of the search space universe and using the data points selected by the dip/peak locator 215 and/or the search space selector 220, the example data fitter 225 of FIG. 2 uses a X² metric to compare the measured HLOG values to one or more combinations within the selected portion of the search space universe. For example, the example data fitter 225 implements EQN (2) to compare measured HLOG values to the selected search space combinations.

To store data representative of search space combinations, the example loop characterizer 165 of FIG. 2 includes an attenuation database 230. The example attenuation database 230 of FIG. 2 stores one or more values that may be used to approximate and/or compute HLOG values for various combinations of overall loop length(s) and bridged tap length(s). For example, the attenuation database 230 may store HLOG(n, loop_length) and HLOG(n, tap_length) values that may be used by the example data fitter 225 to approximate theoretical transfer functions (e.g., by implementing EQN (1)). An example data structure that may be used to implement the example attenuation database 230 is described below in connection with FIG. 3. The example attenuation database 230 of FIG. 2 may be stored using any number and/or type(s) of memory(-ies), memory device(s) and/or storage device(s) 235.

To select a fit, the example loop characterizer 165 of FIG. 2 includes a fit selector 245. The example fit selector 245 of FIG. 2 compares the result of a data fit performed by the example data fitter 225 to determine whether a result of the data fit is acceptable, or if another data fit should be performed by the data fitter 225 based on a different portion of the search space universe and/or different data points. For example, if a first data fit is performed assuming no bridged tap and the result indicates an “ok fit,” the example fit selector 245 directs the dip/peak locator 215, the example search space selector 220 and/or the example data fitter 225 to identify a second portion of the search space universe and then perform a second data fit. The fit selector 245 can then select the better of the two data fits.

To adjust measured HLOG values, the example loop characterizer 165 of FIG. 2 includes a data adjuster 250. The example data adjuster 250 of FIG. 2 adjusts measured HLOG values to compensate for, for example, losses due to and/or caused by co-axial and/or diplexers installed and/or located inside a customer-premises 110. For example when directed by the example fit selector 245, the data adjuster 250 reads and/or obtains pre-computed co-axial and/or diplexer loss values from, for example, a data file and/or memory, and subtracts them from measured HLOG values. In other examples, the data adjuster 250 may compute the co-axial and/or diplexer loss values.

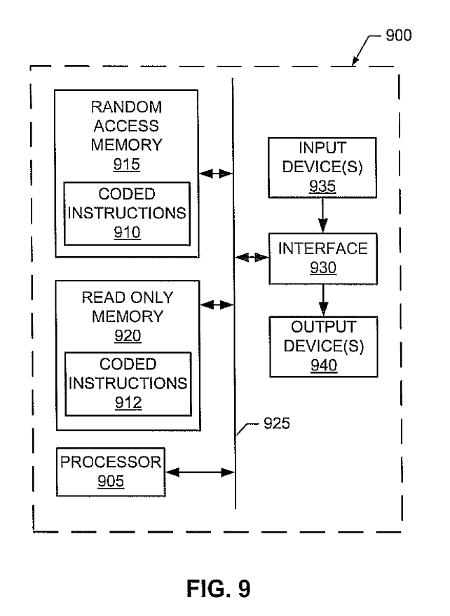

While an example manner of implementing the example loop characterizer 165 of FIG. 1 has been illustrated in FIG. 2, one or more of the elements, processes and/or devices illustrated in FIG. 2 may be combined, divided, re-arranged, omitted, eliminated and/or implemented in any other way. Further, the example user interface 205, the example DSLAM interface 210, the example dip/peak locator 215, the example search space selector 220, the example data fitter 225, the example attenuation database 230, the example fit selector 245, the example data adjuster 250 and/or, more generally, the example loop characterizer 165 may be implemented by hardware, software, firmware and/or any combination of hardware, software and/or firmware. For example, the user interface 205, the DSLAM interface 210, the dip/peak locator 215, the search space selector 220, the data fitter 225, the attenuation database 230, the fit selector 245, the data adjuster 250 and/or, more generally, the loop characterizer 165 may be implemented using practical extraction and report language (PERL) and then executed on a general-purpose computing platform (e.g., the example processor platform 900 of FIG. 9). Further still, the example loop characterizer 165 may include one or more elements, processes and/or devices in addition to, or instead of, those illustrated in FIG. 2, and/or may include more than one of any or all of the illustrated elements, processes and devices.

FIG. 3 illustrates an example data structure that may be used to implement the example attenuation database 230 of FIG. 2. The example data structure of FIG. 3 includes HLOG values 305 for various overall loop lengths (i.e., HLOG(n, loop_length) values) and HLOG values 310 for various bridged tap lengths (i.e., HLOG(n, tap_length) values). The example HLOG values 305 of FIG. 3 include a plurality of entries 315 for respective ones of a plurality of overall loop lengths. To identify an overall loop length, each of the example entries 315 of FIG. 3 includes a loop length field 320. Each of the example loop length fields 320 of FIG. 3 contains a value that represents an overall loop length. The example HLOG values 305 may include entries 315 for any number of loop lengths (e.g., 100 ft. to 6000 ft. in increments of 25 ft.).

To specify HLOG values for a particular overall loop length 320, each of the example entries 315 of FIG. 3 includes entries 325 for respective ones of a plurality of frequencies at which HLOG values are measured and/or computed. Each of the example entries 325 of FIG. 3 contains a value representative of a channel response (e.g., an HLOG value) for the associated overall loop length at the respective frequency. The example HLOG values 305 may include entries 325 for any number of frequencies (e.g., 8 kHz to 17 MHz in increments of 4.3125 kHz).

The example HLOG values 310 of FIG. 3 include entries 330 for respective ones of a plurality of bridged tap lengths. To identify a bridged tap length, each of the example entries 330 of FIG. 3 includes a bridged tap length field 335. Each of the example bridged tap length fields 335 of FIG. 3 contains a value that represents the length of a bridged tap. The example HLOG values 310 may include entries 330 for any number of bridged tap lengths. For example, the following set of bridged tap lengths 335 may be represented in the HLOG values 310: 10 to 40 ft. in 2 ft. increments; 40 to 100 ft. in 3 ft. increments; 100 to 300 ft. in 10 ft. increments; 300 to 800 ft. in 20 ft. increments; and 800 to 2000 ft. in 25 ft. increments.

To specify HLOG values for a particular bridged tap length 335, each of the example entries 330 of FIG. 3 includes entries 340 for respective ones of a plurality of frequencies at which HLOG values are measured and/or computed. Each of the example entries 340 of FIG. 3 contain a value representative of a channel response (e.g., an HLOG value) for the associated bridged tap length at the respective frequency. The example entries 340 (e.g., HLOG values for a particular bridged tap length 335) are computed assuming a loop topology comprising a loop length of 10 ft. and the associated bridged tap length 335. The example HLOG values 310 may include entries 340 for any number of frequencies (e.g., 8 kHz to 17 MHz in increments of 4.3125 kHz).

While the example data structure of FIG. 3 includes both HLOG values 305 and 310, the HLOG values 305 and 310 may be implemented and/or stored using one or more machine accessible data structures. For example, the HLOG values 305 could be read from a first data file, and the HLOG values 310 could be read from a second data file.

While an example data structure that may be used to implement the example attenuation database 230 of FIG. 2 is illustrated in FIG. 3, the example data structure of FIG. 3 may be implemented using any number and/or type(s) of other and/or additional entries, fields and/or data. Further, the entries, fields and/or data illustrated in FIG. 3 may be combined, divided, re-arranged, eliminated and/or implemented in any way. For example, the example HLOG values 305 and 310 may be implemented and/or stored using separate data structures and/or data storage devices. For instance, the HLOG values 305 could be stored in a first memory, and the HLOG values 310 could be stored in a second memory. Moreover, the example data structure may include entries, fields and/or data in addition to, or instead of, those illustrated in FIG. 3, and/or may include more than one of any or all of the illustrated entries, fields and/or data.

FIGS. 4 and 5 illustrate example manners of implementing and/or using the example user interface 205 of FIG. 2. The example user interface of FIG. 4 illustrates example results for a DSL subscriber loop 405 that does not have a bridged tap. The example user interface of FIG. 4 includes a plot of measured HLOG values 410 and a plot of computed HLOG values 415 that most closely match the measured HLOG values 410. The example user interface of FIG. 4 also displays the estimated length 420 (e.g., a first characterizing parameter) of the DSL subscriber loop 405 and an indication 425 (e.g., a second characterizing parameter) indicating that no bridged tap was found. In the illustrated example of FIG. 4, the estimated length 420 also includes information concerning the estimated accuracy of the result. For instance, the estimated length 420 of the DSL subscriber loop 405 is between 4400−275 ft. and 4400+125 ft.

The example user interface of FIG. 5 illustrates example results for a DSL subscriber loop 520 that includes a bridged tap. The example user interface of FIG. 5 includes a plot of the measured HLOG values 525 and a plot of computed HLOG values 530 that most closely match the measured HLOG values 525. The example user interface of FIG. 5 also displays the estimated length 535 (e.g., a first characterizing parameter) of the DSL subscriber loop 520 and an indication 540 (e.g., a second characterizing parameter) indicating that a bridged tap was found and providing the estimated length of the bridged tap (e.g., a third characterizing parameter). In the illustrated example of FIG. 5, the estimated length 535 also includes information concerning the estimated accuracy of the result. For instance, the estimated length 535 of the DSL subscriber loop 520 is between 900−75 ft. and 900+50 ft.

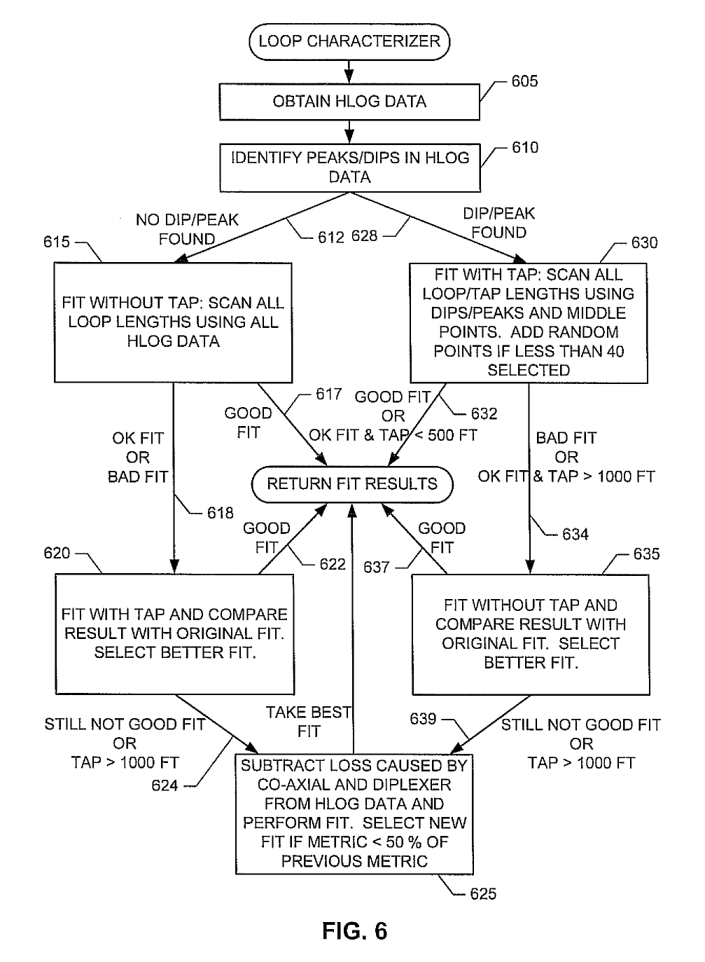

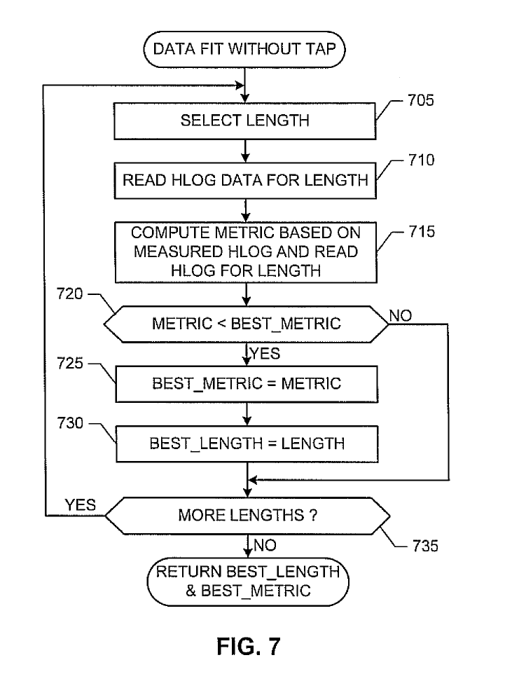

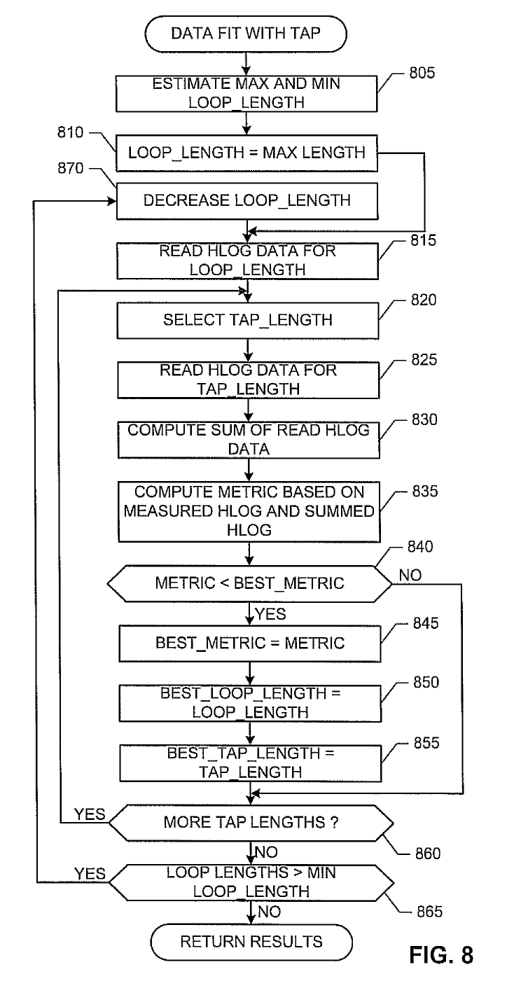

FIG. 6 is a flowchart representative of example machine accessible instructions which may be executed to implement any or all of the example loop characterizers 165 of FIGS. 1 and 2. FIG. 7 is a flowchart representative of example machine accessible instructions which may be executed to perform a data fit assuming no bridged tap is present and/or to implement any or all of the example loop characterizers 165 of FIGS. 1 and 2. FIG. 8 is a flowchart representative of example machine accessible instructions which may be executed to perform a data fit assuming a bridged tap is present and/or to implement any or all of the example loop characterizers 165 of FIGS. 1 and 2. The example machine accessible instructions of FIGS. 6, 7 and/or 8 may be carried out by a processor, a controller and/or any other suitable processing device. For example, the example machine accessible instructions of FIGS. 6, 7 and/or 8 may be embodied in coded instructions stored on a tangible medium such as a flash memory, a ROM and/or RAM associated with a processor (e.g., the example processor 905 discussed below in connection with FIG. 9). Alternatively, some or all of the example machine accessible instructions of FIGS. 6, 7 and/or 8 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example machine accessible instructions of FIGS. 6, 7 and/or 8 may be implemented manually or as any combination of any of the foregoing techniques, for example, any combination of firmware, software, discrete logic and/or hardware. Further, although the example processes of FIGS. 6, 7 and 8 are described with reference to the flowcharts of FIGS. 6, 7 and 8, persons of ordinary skill in the art will readily appreciate that many other methods of implementing the example processes may be employed. For example, the order of execution of the blocks may be changed, and/or one or more of the blocks described may be changed, eliminated, sub-divided, or combined. Additionally, persons of ordinary skill in the art will appreciate that any or all of the example machine accessible instructions of FIGS. 6, 7 and/or 8 may be carried out sequentially and/or carried out in parallel by, for example, separate processing threads, processors, devices, discrete logic, circuits, etc.

The example machine accessible instructions of FIG. 6 begin with a loop characterizer (e.g., the example DSLAM interface 210 of FIG. 2) obtaining measured HLOG data for an identified DSL subscriber loop (e.g., the example DSL subscriber loop 130 of FIG. 1) (block 605). This data may be obtained from, for example, a DSLAM. The loop characterizer (e.g., the example dip/peak locator 215) identifies any oscillations, peaks and/or dips present in the obtained HLOG data (block 610). At block 610, the dip/peak locator also checks if any located oscillations, peaks and/or dips are sufficiently deep and/or wide (e.g., by comparing the depth and/or width to thresholds) to be classified as a dip/peak for purposes of identifying taps.

If no oscillations, peaks and/or dips are located (line 612), the loop characterizer (e.g., the example search space selector 220 of FIG. 2) selects a portion of the search space universe (e.g., all overall loop lengths but no bridged taps), and the loop characterizer (e.g., the example data fitter 225) then performs a data fit to locate the search space combination that most closely matches the measured HLOG data (block 615). For example, the data fitter executes the example machine accessible instructions of FIG. 7 to perform the data fit.

If the loop characterizer (e.g., the example fit selector 245 of FIG. 2) determines that the identified fit is a “good fit” based on, for example, EQN (3) and EQN (4) (line 617), the loop characterizer returns and/or displays the characterizing parameter(s) associated with the identified fit via, for example, the example user interface 205 of FIG. 2. Control then exits from the example machine accessible instructions of FIG. 6.

If the fit selector determines that the identified fit was not a “good fit” (line 618), the loop characterizer (e.g., the example search space selector 220 of FIG. 2) selects a second portion of the search space universe (e.g., estimates a bound on the overall loop length, and also includes bridged taps). The loop characterizer (e.g., the example data fitter 225) then performs a second data fit to locate the search space combination from the second selected portion that most closely matches the measured HLOG data (block 620). For example, the data fitter executes the example machine accessible instructions of FIG. 8 to perform the second data fit.

If the loop characterizer (e.g., the example fit selector 245 of FIG. 2) determines that the second identified data fit is a “good fit” based on, for example, EQN (3) and EQN (4) (line 622), the loop characterizer returns and/or displays the characterizing parameter(s) associated with the identified fit via, for example, the example user interface 205 of FIG. 2. Control then exits from the example machine accessible instructions of FIG. 6.

Returning to block 620, if the fit selector determines that the identified fit was not a “good fit” and/or an identified bridged tap is longer than 1000 ft. (line 624), the loop characterizer (e.g., the example data adjuster 250 of FIG. 2) compensates for losses due to co-axial and/or diplexers. The loop characterizer (e.g., the example data fitter 225) then performs a third fit to locate the search space combination from the second selected portion that most closely matches the measured HLOG data (block 625). The fit selector then selects the best fit of all identified fits (e.g., identified at blocks 615, 620 and/or 625), and returns and/or displays the characterizing parameter(s) associated with the identified fit via, for example, the example user interface 205 of FIG. 2. Control then exits from the example machine accessible instructions of FIG. 6.

Returning to block 610, if one or more oscillations, peaks and/or dips are located (line 628), the loop characterizer (e.g., the example search space selector 220 of FIG. 2) selects a portion of the search space universe (e.g., estimates a bound on the overall loop length, and also includes bridged taps). The loop characterizer (e.g., the example data fitter 225) then performs a data fit to locate the search space combination that most closely matches the measured HLOG data (block 630). For example, the loop characterizer executes the example machine accessible instructions of FIG. 8 to perform the data fit.

If the loop characterizer (e.g., the example fit selector 245 of FIG. 2) determines that the identified fit is a “good fit” based on, for example, EQN (3) and EQN (4), or if the identified fit is an “ok fit” and the identified bridged tap length is less than 500 ft. (line 632), the loop characterizer returns and/or displays the characterizing parameter(s) associated with the identified fit via, for example, the example user interface 205 of FIG. 2. Control then exits from the example machine accessible instructions of FIG. 6.

If the loop characterizer (e.g., the example fit selector 245 of FIG. 2) determines that the identified fit is a “bad fit” based on, for example, EQN (3) and EQN (4), or if the identified fit is an “ok fit” and the identified bridged tap length is greater than 1000 ft. (line 634), the loop characterizer (e.g., the example search space selector 220 of FIG. 2) selects a second portion of the search space universe (e.g., that includes all overall loop lengths but includes no bridged taps since the previous determination of a presence of bridged tap may have been incorrect). The loop characterizer (e.g., the example data fitter 225) then performs a second data fit to locate the search space combination in the second selection portion that most closely matches the measured HLOG data (block 635). For example, the loop characterizer executes the example machine accessible instructions of FIG. 7 to perform the second data fit.

If the loop characterizer (e.g., the example fit selector 245 of FIG. 2) determines that the second identified fit is a “good fit” based on, for example, EQN (3) and EQN (4) (line 637), the loop characterizer returns and/or displays the characterizing parameter(s) associated with the identified fit via, for example, the example user interface 205 of FIG. 2. Control then exits from the example machine accessible instructions of FIG. 6.

If the fit selector determines that the second identified fit was not a “good fit” or the identified bridged tap length was greater than 1000 ft. (line 639), the loop characterizer (e.g., the example data adjuster 250 of FIG. 2) compensates for losses due to co-axial and/or diplexers. The loop characterizer (e.g., the example data fitter 225) then performs a third data fit to locate the search space combination from the original selected portion of the search space universe that most closely matches the measured HLOG data (block 625). The fit selector then selects the best fit of all identified fits (e.g., the fits identified at blocks 630, 635 and/or 625), and the loop characterizer returns and/or displays the characterizing parameter(s) associated with the identified fit via, for example, the example user interface 205 of FIG. 2. Control then exits from the example machine accessible instructions of FIG. 6.

The example machine accessible instructions of FIG. 7 may be executed to perform a data fit of measured HLOG data to a selected portion of a search space universe that does not include bridged taps. The example machine accessible instructions of FIG. 7 begin with a data fitter (e.g., the example data fitter 225 of FIG. 2) selecting an initial loop length (e.g., 100 ft.) (block 705). The data fitter obtains the HLOG values associated with the loop length (e.g., from an entry 315 of the example HLOG values 305 of FIG. 3) (block 710). The data fitter then computes a metric that represents the extent of match between measured HLOG values and the obtained HLOG values (block 715). For example, the data fitter uses EQN (2) to compute a X² value.

If the computed metric (e.g., the X² value) is less than a previously best metric (block 720), the data fitter records the current metric (block 725) and the associated loop length (block 730). If no more loop lengths remain to be processed (block 735), control exits from the example machine accessible instructions of FIG. 7. If more loop lengths are to be processed (e.g., the currently considered loop length is <6000 ft) (block 735), control returns to block 705 to process the next loop length. At block 705 the loop length is incremented by, for example, 25 ft.

Returning to block 720, if the metric (e.g., the X² value) is not less than the previously best metric (block 720), control proceeds to block 735 without recording the current metric or loop length.

The example machine accessible instructions of FIG. 8 may be executed to perform a data fit of measured HLOG data to a selected portion of a search space universe that includes one bridged tap. Based on the descriptions within this patent, persons of ordinary skill in the art will be readily able to modify the example machine accessible instructions of FIG. 8 to accommodate two or more bridged taps and, thus, the process for two or more bridged taps is not explicitly illustrated. The example machine accessible instructions of FIG. 8 begins with a data fitter (e.g., the example data fitter 225 of FIG. 2) estimating a maximum and minimum loop length based upon the measured HLOG data (block 805). As described above, the maximum and minimum loop lengths may be adjusted to increase the selected portion of the search space universe. The data fitter sets the currently considered loop length to the maximum loop length (block 810).

The data fitter obtains the HLOG values associated with the loop length (e.g., from an entry 315 of the example HLOG values 305 of FIG. 3) (block 815). The data fitter then selects a bridged tap length (block 820) and obtains the HLOG values associated with the bridged tap length (e.g., from an entry 330 of the example HLOG values 310 of FIG. 3) (block 825). The data fitter then combines the obtained HLOG values using, for example, EQN (1) (block 830).

The data fitter then computes a metric that represents the extent of match between measured HLOG values and the computed HLOG values (block 835). For example, the data fitter uses EQN (2) to compute a X² value. If the metric (e.g., the X² value) is less than a previously best metric (block 840), the data fitter records the metric (block 845), the associated loop length (block 850), and the associated bridged tap length (block 855). If more bridged tap lengths are to be processed (block 860), control returns to block 820 to process the next bridged tap length.

If no more bridged tap lengths remain to be processed for the presently considered overall loop length (block 860), the data fitter determines if any more loop lengths remain to be processed (block 865). If more loop lengths remain to be processed (block 865), control returns to block 870 to decrease the loop length and perform another comparison. If no more loop lengths remain to be processed (block 865 control exits from the example machine accessible instructions of FIG. 8.

Returning to block 840, if the metric (e.g., the X² value) is not less than a previously best metric (block 840), control proceeds to block 860 without recording the current metric, loop length or bridged tap length.

FIG. 9 is a schematic diagram of an example processor platform 900 that may be used and/or programmed to implement any portion(s) and/or all of the example loop characterizers 165 of FIGS. 1 and 2. For example, the processor platform 900 can be implemented by one or more processors, processor cores, microcontrollers, DSPs, DSP cores, ARM processors, ARM cores, etc.

The processor platform 900 of the example of FIG. 9 includes at least one programmable processor 905. The processor 905 executes coded instructions 910 and/or 912 present in main memory of the processor 905 (e.g., within a RAM 915 and/or a ROM 920). The processor 905 may be any type of processing unit, such as a processor core, a processor and/or a microcontroller. The processor 905 may execute, among other things, the example machine accessible instructions of FIGS. 6, 7 and/or 8 to implement any or all of the example loop characterizers 165 described herein. The processor 905 is in communication with the main memory (including a ROM 920 and/or the RAM 915) via a bus 925. The RAM 915 may be implemented by DRAM, SDRAM, and/or any other type of RAM device, and ROM may be implemented by flash memory and/or any other desired type of memory device. Access to the memory 915 and 920 may be controlled by a memory controller (not shown). The RAM 915 may be used to store and/or implement, for example, the example attenuation database 230 of FIG. 2.

The processor platform 900 also includes an interface circuit 930. The interface circuit 930 may be implemented by any type of interface standard, such as a USB interface, a Bluetooth interface, an external memory interface, serial port, general purpose input/output, etc. One or more input devices 935 and one or more output devices 940 are connected to the interface circuit 930. The input devices 935 and/or output devices 940 may be used to implement the example user interface(s) 205 and/or the example DSLAM interface 210 of FIG. 2, and/or to obtain the example HLOG values 305 and 310 of FIG. 3.

Of course, persons of ordinary skill in the art will recognize that the order, size, and proportions of the memory illustrated in the example systems may vary. Additionally, although this patent discloses example systems including, among other components, software or firmware executed on hardware, it will be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, persons of ordinary skill in the art will readily appreciate that the above described examples are not the only way to implement such systems.

At least some of the above described example methods and/or apparatus are implemented by one or more software and/or firmware programs running on a computer processor. However, dedicated hardware implementations including, but not limited to, an ASIC, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a disk or tape); a magneto-optical or optical medium such as a disk; or a solid state medium such as a memory card or other package that houses one or more read-only (non-volatile) memories, random access memories, or other re-writable (volatile) memories; or a signal containing computer instructions. A digital file attachment to e-mail or other self-contained information archive or set of archives is considered a distribution medium equivalent to a tangible storage medium. Accordingly, the example software and/or firmware described herein can be stored on a tangible storage medium or distribution medium such as those described above or equivalents and successor media.

To the extent the above specification describes example components and functions with reference to particular devices, standards and/or protocols, it is understood that the teachings of the invention are not limited to such devices, standards and/or protocols. For instance, DSL, DSPs, ITU-T G.992.x, ITU-T G993.x, and ITU-T G.997x. represent examples of the current state of the art. Such systems are periodically superseded by faster or more efficient systems having the same general purpose. Accordingly, replacement devices, standards and/or protocols having the same general functions are equivalents which are intended to be included within the scope of the accompanying claims.

Although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method comprising:
selecting a portion of a search space based on a measured transfer function response, the search space defining a plurality of combinations of transmission line parameters; and
identifying a characterizing parameter of a digital subscriber line (DSL) subscriber loop from the selected portion of the search space, the characterizing parameter having an associated transfer function that substantially corresponds with the measured transfer function response.

2. A method as defined in claim 1, further comprising receiving the measured transfer function response from a first DSL modem, the first DSL modem to measure the transfer function response based on signals transmitted from a second DSL modem to a first DSL modem.

3. A method as defined in claim 2, further receiving the measured transfer function response from the first DSL modem via the second DSL modem.

4. (canceled)

5. A method as defined in claim 1, wherein the portion of the search space is selected based upon a presence of a dip in the measured transfer function response.

6. (canceled)

7. (canceled)

8. (canceled)

9. (canceled)

10. A method as defined in claim 1, wherein the search space is defined by a plurality of combinations of loop lengths and bridged tap lengths, wherein each of the plurality of combinations has an associated computed transfer function response.

11. A method as defined in claim 10, wherein a computed transfer function response for a combination of a first loop length and a first bridged tap length is determined by:
obtaining first attenuation data associated with the first loop length;
obtaining second attenuation data associated with the first bridged tap length; and
computing a sum of the first and second attenuation data.

12. A method as defined in claim 1, further comprising comparing the measured transfer function response with computed transfer function responses associated with the selected portion of the search space, the identified characterizing parameter associated with a computed transfer function response being selected based on a difference from the measured transfer function response.

13. A method as defined in claim 1, wherein the characterizing parameter comprises at least one of a loop length or a bridged tap length.

14. A method as defined in claim 1, further comprising:
determining a value representative of a match between the measured transfer function response and a computed transfer function response associated with the characterizing parameter; and
when the value exceeds a threshold:
select a second portion of the search space when the value exceeds a threshold; and
identify a second characterizing parameter of the DSL subscriber loop from the second selected portion of the search space, the second characterizing parameter having an associated transfer function that substantially corresponds with the measured transfer function response.

15. A method as defined in claim 14, further comprising:
adjusting the measured transfer function response to compensate for at least one of a diplexer or a coaxial cable; and
identifying the second charactering parameter of the DSL subscriber loop based on the adjusted measured transfer function response.

16. A method as defined in claim 1, further comprising:
selecting a portion of the measured transfer function response based on a characteristic of the transmission function response; and
using the selected portion of the measured transfer function response to identify the characterizing parameter.

17. A method as defined in claim 16, wherein the characteristic of the measured transfer function response comprises a presence of a dip in the measured transfer function response, and the portion of the measured transfer function response comprises a set of values of the measured transfer function occurring about a location of the dip.

18. (canceled)

19. A method as defined in claim 1, wherein the portion of the search space is not all of the search space.

20. An article of manufacture storing machine readable instructions which, when executed, cause a machine to:
select a portion of a search space based on a measured transfer function response, the search space defining a plurality of combinations of transmission line parameters; and
identify a characterizing parameter of a digital subscriber line (DSL) subscriber loop from the selected portion of the search space, the characterizing parameter having an associated transfer function that substantially corresponds with the measured transfer function response.

21. An article of manufacture as defined in claim 20, wherein the machine accessible instructions, when executed, cause the machine to receive the measured transfer function response from a first DSL modem, the first DSL modem to measure the transfer function response based on signals transmitted from a second DSL modem to a first DSL modem.

22. (canceled)

23. An article of manufacture as defined in claim 20, wherein the portion of the search space is selected based upon a presence of a dip in the measured transfer function response.

24. (canceled)

25. (canceled)

26. (canceled)

27. An article of manufacture as defined in claim 20, wherein the search space is defined by a plurality of combinations of loop lengths and bridged tap lengths, wherein each of the plurality of combinations has an associated computed transfer function response.

28. An article of manufacture as defined in claim 27, wherein the machine accessible instructions, when executed, cause the machine to determine a computed transfer function response for a combination of a first loop length and a first bridged tap length by:
obtaining first attenuation data associated with the first loop length;
obtaining second attenuation data associated with the first bridged tap length; and
computing a sum of the first and second attenuation data.

29. (canceled)

30. An article of manufacture as defined in claim 20, wherein the characterizing parameter comprises at least one of a loop length or a bridged tap length.

31. (canceled)

32. (canceled)

33. An article of manufacture as defined in claim 20, wherein the machine accessible instructions, when executed, cause the machine to:
select a portion of the measured transfer function response based on a characteristic of the transmission function response; and
use the selected portion of the measured transfer function response to identify the characterizing parameter.

34. (canceled)

35. (canceled)

36. An apparatus comprising:
a selector to eliminate a portion of a database based on a presence of at least one of a dip or a peak in a measured transfer function response, the database defining a plurality of combinations of transmission line parameters; and
a data fitter to identify a characterizing parameter of a digital subscriber line (DSL) subscriber loop from a remaining portion of the database, the characterizing parameter having an associated transfer function that substantially corresponds with the measured transfer function response.

37. An apparatus as defined in claim 36, wherein a first DSL modem is to measure the transfer function response for the DSL subscriber loop based on signals transmitted from a second DSL modem to the first DSL modem.

38. An apparatus as defined in claim 37, wherein the first DSL modem is to be disposed at a customer-premises, and the second DSL modem is to be disposed at at least one of a central office or a remote terminal.

39. (canceled)

40. (canceled)

41. An apparatus as defined in claim 36, wherein the remaining portion of the database is defined by a plurality of loop lengths having respective computed transfer function responses.

42. An apparatus as defined in claim 36, wherein the data fitter is to compare the measured transfer function response with one or more computed transfer function responses defined by the remaining portion of the database.

43. An apparatus as defined in claim 42, wherein the data fitter is to compute a transfer function response for a combination of a particular loop length and a particular bridged tap length by:
obtaining first attenuation data associated with the particular loop length;
obtaining second attenuation data associated with the particular bridged tap length; and
computing a sum of the first and second attenuation data.

44. (canceled)

45. An apparatus as defined in claim 36, wherein the characterizing parameter comprises at least one of a loop length or a bridged tap length.

46. An apparatus as defined in claim 36, further comprising a fit selector to determine a value representative of a match between the measured transfer function response and a computed transfer function response associated with the characterizing parameter, and to when the value exceeds a threshold:
direct the selector to eliminate a second portion of the database; and
direct the data fitter to identify a second characterizing parameter of the DSL subscriber loop from a second remaining portion of the database, the second characterizing parameter having an associated transfer function that substantially corresponds with the measured transfer function response.

47. (canceled)

48. An apparatus as defined in claim 36, further comprising:
a dip/peak locator to detect the presence of at least one of a dip or a peak in the measured transfer function response and to select a portion of the measured transfer function response occurring about a location of the at least one of the dip or the peak, wherein the data fitter is to identify the characterizing parameter based on the selected portion of the measured transfer function.

49. (canceled)
